(19) United States
(12) Patent Application Publication
(10) Pub. No.: US 2020/0002027 A1
(43) Pub. Date: Jan. 2, 2020

(54) Hollow structure for creating pressurized space habitats

(71) Applicant: Manuel Victor Borrego Borrego, Alcala de Guadaira (ES)

(72) Inventor: Manuel Victor Borrego Borrego, Alcala de Guadaira (ES)

(21) Appl. No.: 16/022,742

(22) Filed: Jun. 29, 2018

(51) Int. Cl. B64G 1/12; B64G 1/46

(52) U.S. Cl. CPC B64G 1/12; B64G 9/00; B64G 1/46

(57) ABSTRACT

Hollow structure to create pressurized space habitats which consists of a pressurized space habitat created from a set of connectable space modules (2) that, once assembled, define a volumetric body with a pressurized interior hollow space (1a), with the total volume of this structure (1) being greater than the sum of the volume of the volumetric bodies that these modules (2) form. The modules (2) are pressurized, with structural modules (2′) and identical standardized modules also being able to exist. For the connection between modules (2), they present flat connection faces (20) with a coinciding door (4) to be fit together upon confronting the respective faces (20) of the two adjacent modules (2), whose doors (4) are fastened and pressurized with connection means (6) and sealing means (7), with the two modules (2) communicating together internally.

### CROSS-REFERENCE TO RELATED APPLICATIONS

Not applicable

### STATEMENT REGARDING FEDERALLY SPONSORED RESEARCH OR DEVELOPMENT

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION TECHNICAL FIELD

### Field of the Invention

The invention's field of application is framed within the aerospace industry, focusing particularly on the area of the industry dedicated to the manufacturing of heavy structures and spaces or pressurized habitats.

### Description of Related Art

Currently the space habitats that have been designed are formed by space modules. The space modules are limited by the volume of the fairing of the rockets in the launches.

The habitable volume that is achieved is that which is sent to space, that is to say, only that which is within each module.

To date the space modules are only joined or connected by passages and in no case are they stackable nor do they generate pressurized and habitable volumes between the modules.

Some companies such as Bigelow construct inflatable modules but the way of connecting the modules is the same.

The objective of this invention is, then, to develop an improved construction system of space habitats that allows incrementing the available space in them without being limited to that which each rocket, launching module or aerospace craft can transport.

Furthermore, and in reference to the current state of the art, it can be pointed out that the existence of any other hollow structure for creating pressurized space habitats is unknown, at least by the applicant, or any other invention of similar application which presents equal or similar technical, structural and constitutive characteristics to those that are claimed herein.

### BRIEF SUMMARY OF THE INVENTION

The invention, refers to a hollow structure for creating pressurized space habitats, contributing advantages and characteristics to the function to which they are dedicated, which are described in detail below and which signify a noteworthy novelty to the current state of the art.

More specifically, the purpose of the invention is focused on a hollow structure applicable for creating pressurized space habitats, which are distinguished by being configured by the union of multiple space modules that are joined together and that allow assembling this structure in situ in space, thus occupying much less volume for their launching into space than that which it provides as useable once assembled.

### BRIEF DESCRIPTION OF THE DRAWINGS

To complement the description that is made herein and for the purpose of aiding a better understanding of the characteristics of the invention, this descriptive report is accompanied, as an integral part thereof, by a set of drawings in which items have been shown which include but are not limited to the following:

FIGS. 1 and 2-A. They show perspective views of a first example of the realization of the hollow structure which is the subject of the invention, specifically an example with a parallelepiped shape formed by pressurized modules and non-pressurized structural modules, with FIG. 1 showing the initial assembly phase with the pressurized modules and

FIG. 2 the complete structure once the structural modules are also added, noting the general configuration of the structure and the principal parts that it includes.

FIG. 2-B shows a perspective view of one of the structural modules of the example of structure shown in FIG. 2-A.

FIG. 3 shows a perspective view of another example of the hollow structure, according to the invention, in this case in the shape of a hollow cylinder with spherical end caps that close the ends, showing the example without said end caps being connected in order to facilitate the observation of the hollow interior space that defines the modules that comprise it once assembled in order to generate this structure.

FIG. 4 shows an expanded view of one of the end caps of the invention's structure, according to the example shown in FIG. 3, noting the placement of the modules that comprise it.

FIG. 5 shows a perspective view of different module models, noting their varied configuration, according to the shape of the structure to create, and the door with cover that they incorporate in the flat connecting faces between them.

FIG. 6 shows a perspective view of a portion of an example of a hollow structure, specifically an example in cylindrical form, noting its creation based on standardized modules.

FIG. 7 shows a sectional view, according to cut A indicated in FIG. 6, of the example of the structure shown in that figure, noting the union between the modules through the doors of its adjacent flat faces.

FIG. 8 shows a perspective view of two contiguous standard modules, according to the example of structure shown in FIG. 6, noting the connecting doors that are incorporated on their flat faces and the doors of the faces that lead to the interior hollow of the structure.

FIG. 9 shows a perspective view of four contiguous standard modules, according to the example of structure shown in FIG. 6, noting in this case the connection and sealing means between them in the interior part of the structure that they create.

FIG. 10. It shows a sectional view, according to cut B indicated in FIG. 9, of the connection between two contiguous modules, noting in it the connecting and sealing means between them in the interior part of the structure and in the doors of their adjacent faces.

FIGS. 11 and 12 show views of the perforated joint that constitutes the internal sealing means between modules that make up the structure, with FIG. 11 showing an example of this perforated rolled joint and FIG. 12 a segment of the joint with its bolts.

FIGS. 13 and 14 show views, in partially sectioned and sectioned perspective according to the longitudinal cut, respectively, of the details of the approach and buffering device that the structure includes to facilitate the connection between modules, noting the parts and elements that comprise it.

FIG. 15 shows a sectional view of the approach and buffering device shown in FIGS. 13 and 14, in this case shown once it is incorporated to the doors of the modules to be joined and in connection position.

FIG. 16 shows a perspective view of another example of the hollow structure, according to the invention, in this case an example in a cylindrical shape, closed at its ends with flat bases.

FIGS. 17 and 18 show sectional views of the structure shown in FIG. 16, according to cut C indicated in it, represented in their phases of a first option of expansion mode of the structure from inside it.

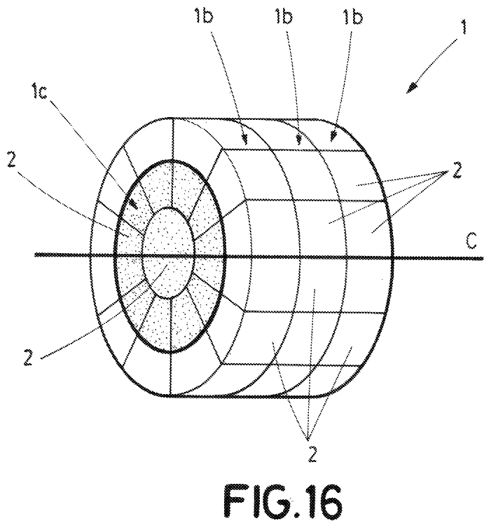

And FIGS. 19, 20 and 21 also show sectional views of the structure, according to the same cut as indicated in FIG. 16, represented in this case in respective phases of a second option of expansion mode from the exterior.

### DETAILED DESCRIPTION OF THE INVENTION

The hollow structure for creating pressurized space habitats that the invention proposes is configured, then, as a novelty within its field of application, since according to its implementation and in a restrictive manner, it satisfactorily fulfils the objectives indicated earlier, with the characterizing details that make it possible and that distinguish it appropriately included in the final claims that accompany this description.

More specifically, what the invention proposes, as noted above, is a specially designed structure with the end purpose of creating pressurized space habitats, for different uses that may be required in space. It is distinguished by being configured from the union of multiple modules, which at least in part are habitable and pressurized living quarters in space, but that, in any case, present a geometrically variable configuration, apt for being coupled together. They comprise a larger hollow structure, in such a way that they allow mounting this structure in situ in space, thus occupying much less volume for their launching into space than that which it provides as useable once it is assembled, since in the launching, the modules are unassembled and each one is an independent module, and, once assembled, in addition to the space of each module, it obtains the structure's interior hollow space whose perimeter is created by these modules.

Therefore, and more specifically, the acclaimed hollow structure consists of a pressurized space habitat created from a set of modules connected together in such a way that they define a body larger than the sum of the volume occupied by these modules, which are transported unassembled when launched, either the entire set, or else by parts or individually, for example, by an aerospace craft in the form of a tug.

In turn, these modules, preferably most of them, are pressurized space modules that define in themselves space habitats that, by being coupled together, in addition to the perimeter of the structure that they create, allow defining a common space habitat that is added to the general space of this structure, and the rest, where applicable, can consist simply of structural modules that, either, used alone, make up part of the perimeter of the pressurized habitat that the hollow structure defines once it is assembled, or else they serve to connect its parts.

In any event, the modules are defined by volumetric bodies of a variable geometric layout, according to the configuration, which is also variable, of the hollow structure to which they are dedicated and the position they occupy. Thus, for example, if the hollow structure is a parallelepiped body where the modules are prismatic bodies that, at least, define its edges and, optionally, also intermediate sections that connect these edges and/or the bases and the sides of this body together. Or, for example, if the hollow structure is a hollow cylinder, the modules will consist of bodies with the shape of cylinder sectors that form successive circular rings that define the circular walls of said cylinder, including, optionally, modules in the shape of circular sectors and circular modules that shape the bases that close both ends of the cylinder. Or, for example, if the hollow structure is a sphere, the modules will be formed by bodies in the shape of segments of the sphere.

In any case, preferably, the modules of the same hollow structure, at least most of them, are standardized modules, that is, having the same shape and configuration, in order to facilitate and economize their manufacture.

For its part, in order to achieve the mentioned connection between the modules, they are provided, on one, several or all its faces, depending on the configuration and the position they occupy in the structure, in any case in those flat faces that are abutted to the contiguous module, with door-like openings with an extractable pressurized cover whose shape and dimensions coincide in order to adapt together upon confronting the respective faces of the modules to connect, as well as the connection and sealing means in order to join them without compromising the pressurized interior of the structure, with the modules communicating internally together. In addition, some or all of the modules have this door on its side that is oriented towards the interior space of the structure, once formed, to allow passing towards said space.

Moreover, in order to facilitate this connection, an approach and buffering device is considered based on a pneumatic piston and electromagnets that, in addition, is advantageously detachable to allow its reuse in each connection, avoiding the need to incorporate it as a fixed element in each door, with which besides gaining the space that it occupies, the manufacturing costs are reduced.

The principal advantages that this structure provides are, among others, the following:
With it, larger habitable volumes are obtained than that which is sent to space within the rockets, since the modules are used to create a hollow structure.
The structure that is formed can be increased in size by coupling additional modules sent in launchings after the initial construction.
The assembly of the structure by connecting together the applicable space modules and its later expansion can be done with the astronauts working from inside these modules, or from within the respective structure, and optionally in their start, from inside the tug that is launched into space, being protected from solar storms, solar radiation, cosmic radiation, space debris, micro-meteorites, etc. As is well known, radiation in space is ultimately lethal, for which reason the exposure time has to be minimal, the connection and assembly system of the invention's structure allows protecting the astronauts, just as in a factory the workers are protected from chemical agents, that is, reducing the time of exposure and intensity.
The structure created by the modules can have different configurations, for example, a hollow tube of circular or polygonal cross-section, a hollow sphere or any regular or irregular shape or geometric figure that, by being hollow, generates a much larger habitable space than the sum of the space that each module occupies, thus more habitable space is managed than what is sent to space. In fact, it can exceed by more than twenty times the volume of the space of the sum of the space launchings that are needed for the construction; it all depends on the dimensions of the structure that is constructed out of the modules.
Optionally, more modules can be manufactured within the initial structure already assembled, in order to enlarge its dimensions, as long as the modules are smaller than the volume of the pressurized hollow space that is obtained, which is the most optimal solution, although they can also be manufacture in another place.
The approach and buffering device is reusable, since, after use in connecting the doors of two modules to be joined, it is dismounted and again mounted on another module and can be used as many times as is necessary. It is bolted to the door in the same place where the cover that closes the door goes before connecting, for which reason it can be dismounted from inside the module.
The modules, especially of certain configurations of the structure, are standard modules for forming a hollow structure that allows containing the largest possible habitable space, although it is not ruled out that the structural modules can also be used to construct bridges or connections between parts of the structure, landing strips, buildings, greenhouses, or other space constructions, by connecting non-standard modules.

The fact that the modules can be serial produced is advantageous since a cylinder or other hollow figures can be constructed with standard modules, lowering the manufacturing cost and simplifying the assembly. When producing the modules, standard pre-installations can be taken into account, such as slots or handles of easy assembly for solar panels, connectors, outlets or to connect other accessories, depending on the needs both inside the modules and outside, avoiding have to drill or modify the structure once it is finished in order to place, for example, a sensor, a solar panel or an antenna, etc.
In order to repair or substitute a damaged module, a barrier can be formed with other modules from the interior of the structure, so the damaged module can be removed without it compromising the pressurized state.

What the invention provides, therefore, is a structure that defines a habitable and expandable volume, being created from space modules, so that they generate a hollow structure that, in turn, houses a pressurized habitat. The modules can have different functions, such as that of working as treatment systems, air purifiers, greenhouses and even completely functional space modules.

A single module can be habitable and, by connecting it to others, a pressurized volume is created much larger than the sum of all.

The described hollow structure to create pressurized space habitats represents, then, an innovation of structural and constitutive characteristics unknown until now, reasons that together with its practical utility, giving it sufficient grounds for obtaining the privilege of exclusivity that is requested.

### Description of the Preferred Embodiment

In view of the mentioned figures, and in accordance with the numeration adopted, one can observe in them unlimited examples of realization of the hollow structure for creating pressurized space habitats of the invention, which include the parts and elements that are indicated and described in detail below.

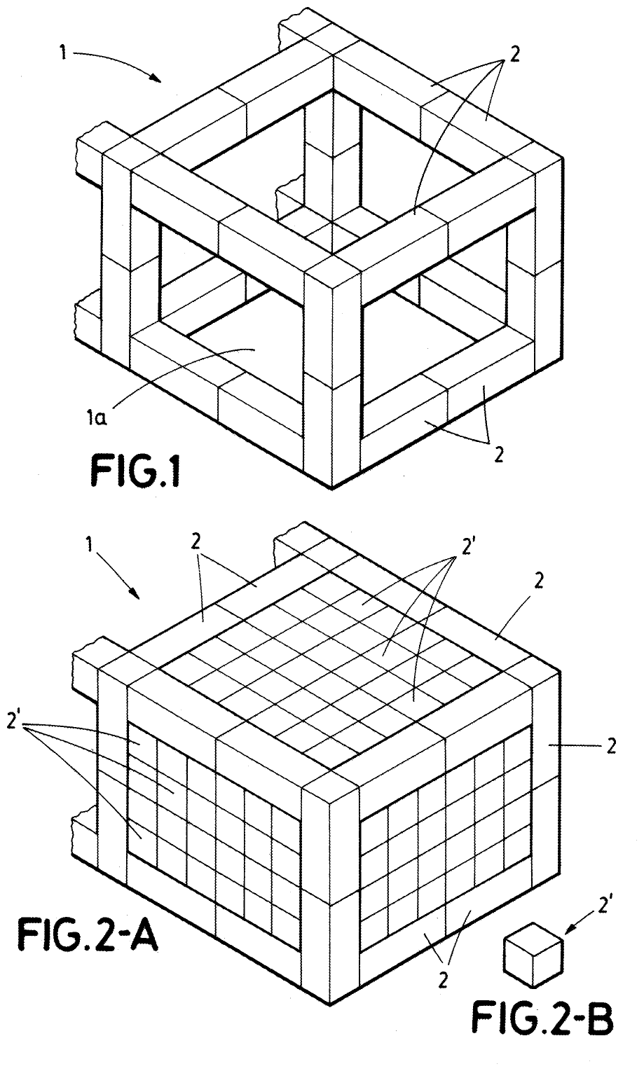

Thus, as observed in FIG. 1, the structure (1) in question consists of a pressurized space habitat created from a set of space modules (2) that can be connected together so that, once assembled, it define a volumetric body of a variable configuration with a pressurized interior space (1a) and the total volume of said structure (1), is greater than the sum of the volume that the volumetric bodies alone occupy that form these modules (2).

FIGS. 2, 3, 4 and 16 show some examples of the varied shapes that the structure (1) can adopt once assembled, with these shapes having to be understood just as examples, not limited to them, and that, in turn, the shape of the modules (2) varies according to the shape of the structure (1) and of the position that they occupy in it.

Preferably, the structure is comprised only of space modules (2) that are, in turn, pressurized modules, that is, that they define in themselves pressurized space habitats, as shown in the examples of FIGS. 1, 3 and 16, or optionally, it includes structural modules (2′) that make up part of the perimeter of the hollow structure (1) once assembled, or serve as connection between parts of it, as shown in FIG. 2-A. And in one case or the other, the structure (1) has, at least in part of it, multiple identical modules (2), susceptible to being produced in a standardized manner.

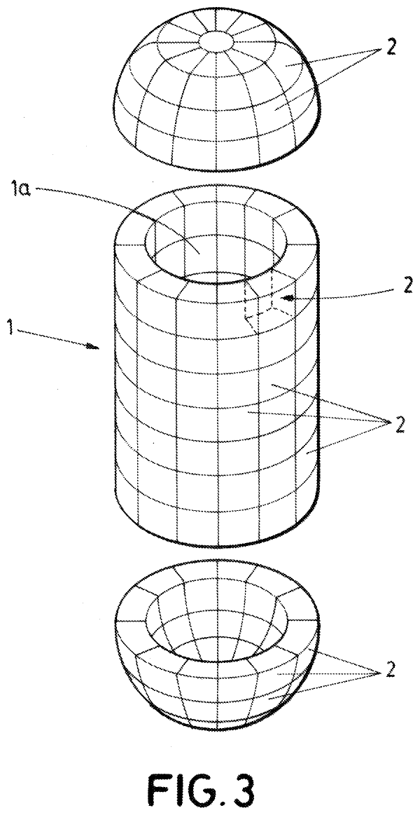

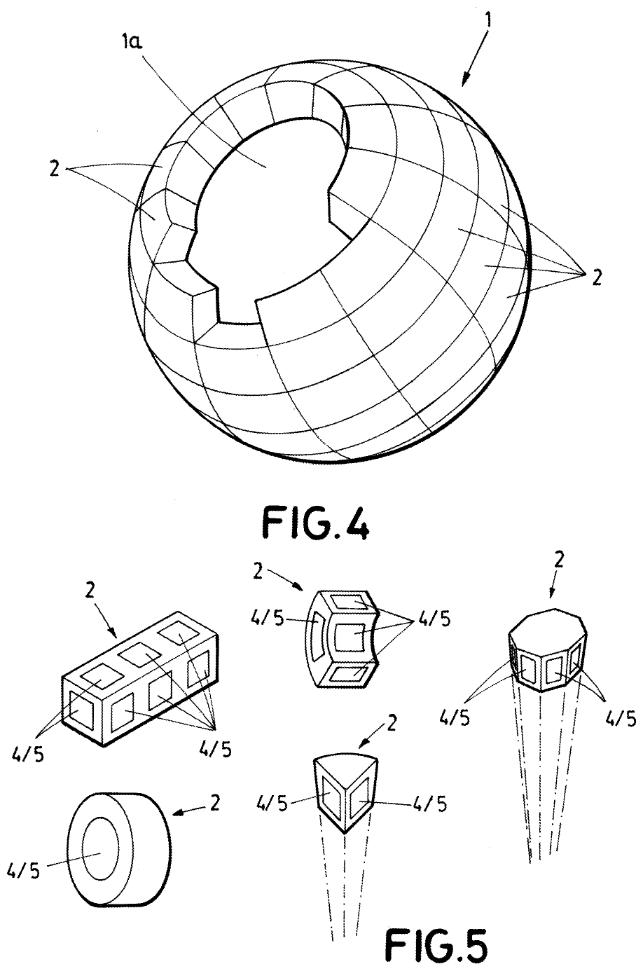

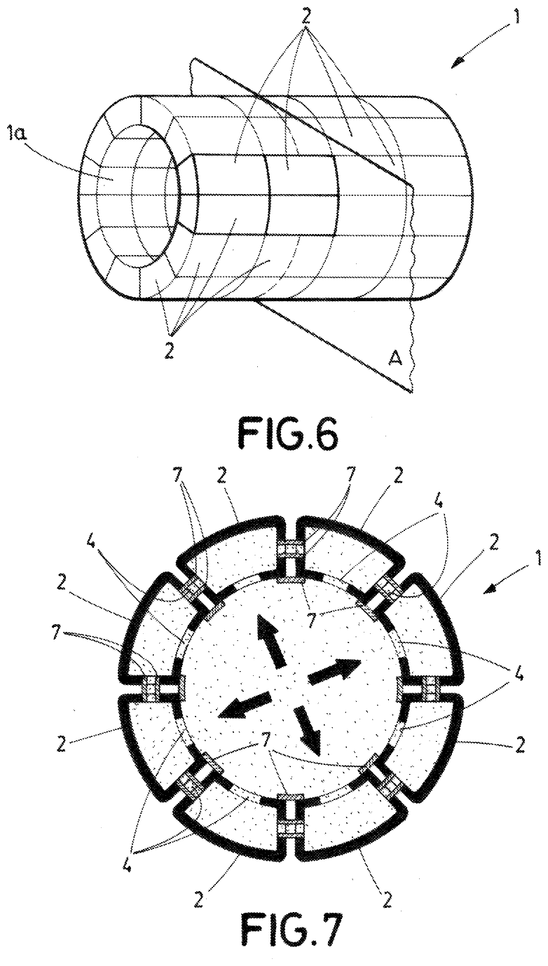

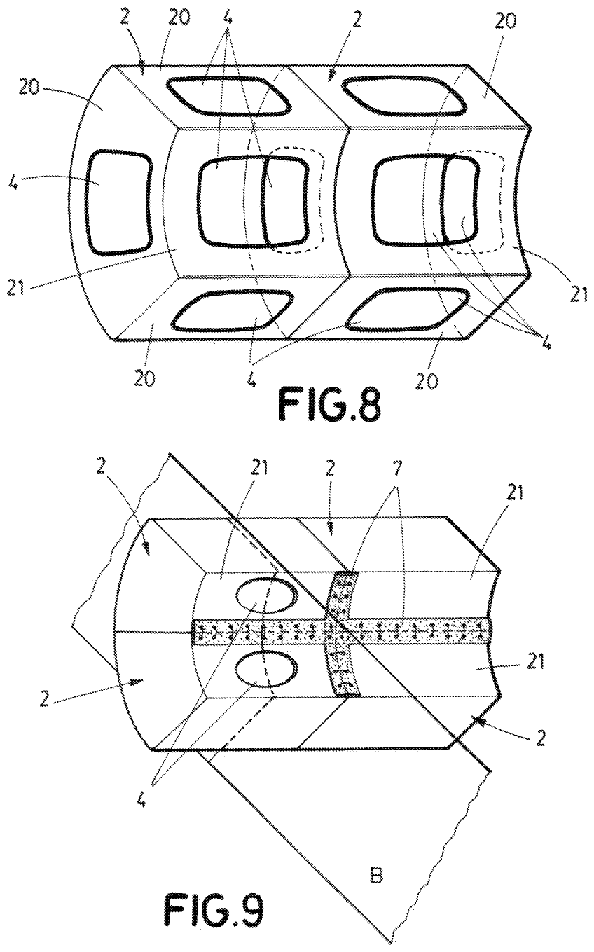

In the example of FIG. 3, where the structure (1) is a cylinder of spherical bases, the modules (2) of its central cylindrical section are all identical and consist of cylinder sectors that, joined radially, define successive circular rings (1b) making up the perimeter of the interior hollow space (1a) of the structure (1). In FIG. 4, one may observe how, in other parts of the structure (1), such as a spherical cap, the modules (2) have a different shape in order to fit in a certain part thereof.

In FIG. 5 various examples of varied shapes are observed that the modules (2) can present, including in any case, flat connecting faces (20) which are abutted and connected to the contiguous module (2), being fastened through connecting means (6) and sealing means (7) that ensure the pressurization of the interior hollow space (1a) of the structure (1).

Preferably, for the connection between modules (2), in the flat connecting faces (20), they have, at least, one door (4) that, prior to said connection, especially when it deals with pressurized space modules (2), is closed with an extractable pressurized cover (5) and whose shape and dimensions coincide with all the modules (2) in order to adapt together by confronting the respective faces (20) of two adjacent modules (2) to be connected, and these doors (4) once confronted are fastened and pressurized along the perimeter to each other with the cited connecting means (6) and sealing means (7), with the two modules (2) communicating inside with each other.

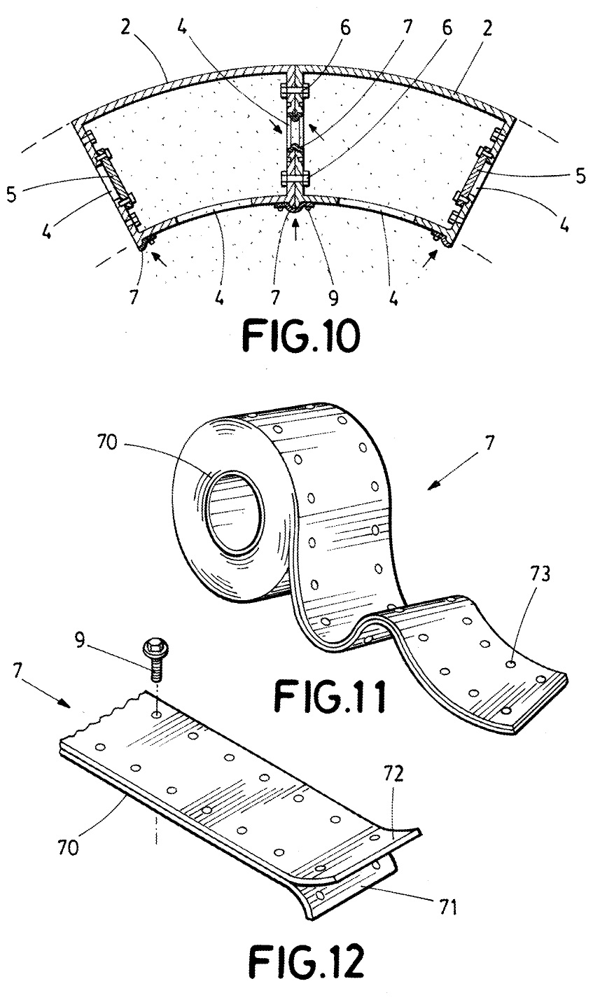

In addition, preferably, these sealing means (7) are also incorporated in the interior connecting areas between modules (2), as shown in FIGS. 9 and 10.

Preferably, these connecting means (6) are mechanical connecting means that consist, for example, of thru-axles (60) that, crossing the partition of the flat face (20) of both modules (2) are fastened at their respective threaded ends by means of corresponding nuts, without ruling out other possibilities such as screws, tension cables or others.

And the sealing means (7), preferably, consist of a joint (70) in the form of a band with perforations (73) for their fastening by means of bolts embracing the edge of each door, as shown in FIG. 10. For example, this joint (70) consists of a band formed by two layers, one of Kevlar (71) and another of a thermoplastic material (72), in such a way that, upon heating the band on the joint of the modules (2), the joint would be thermo-sealed. In addition, the edges of the joint (70), preferably, are reinforced with a metallic profile fastened by means of bolts or rivets (9), as shown in FIGS. 11 and 12.

In any case, it is important to point out that the sealing joints (70) allow pressurizing the connections between modules (2) right on the interior border that remains inside the hollow structure (1) and also when there is a door that communicates two modules (2), since thanks to them multiple faces can be pressurized at the same time. The pressure of the habitat or hollow interior space (1a) of the structure (1) once assembled and pressurized, as observed in the arrows of FIG. 3, always work in favour of the connection, since the air tries to get out, for which reason it presses the joints against the wall of the modules (2). If joints were put on the external connections, the force of the air pressure would push the joints outwards.

The joints (70) are manufactured in an appropriate way so that they remain protected from space conditions such as micro-meteorites, cosmic radiation, solar radiation, extreme temperatures (−180° C. in the shadow and 122° C. on the side lighted by the sun), space debris, etc. The joint protection is important in keeping the pressurization from being compromised.

The joints (70) are not subject to structural forces, since they are on the edge that connects the modules (2) and not between the modules. The structural forces are buffered by the mechanical connection means (6), which avoids breakage of the joint due to mechanical fatigue and it even protects it from small tremors. FIG. 10 shows with arrows the force that the pressure exerts from inside outwards on the joints, bringing about its being trapped on the wall of the modules.

Alternatively, the sealing means (7) may consist of cold welds, fabric seam connections, rubber with covers, glue or others.

In any case, preferably, some or all of the modules (2) also have the door (4) with extractable pressurized cover (5) on one of its internal faces (21), that is, which is oriented towards the interior hollow space (1a) of the structure (1) once assembled, allowing access to it when the structure (1) is assembled and pressurized.

In addition, in order to facilitate the connection between the two doors (4) of the flat faces (2) of two adjacent modules (2) to be joined, the invention's structure (1) has an approach and buffering device (8) by means of a pneumatic piston (82) and electromagnets (81, 84) that, preferably, is dismountable and reusable in other connections in assembling the same structure (1) by means of incorporating it on the respective doors (4) of the modules (2) to connect, after removing the cover (5) that closes them.

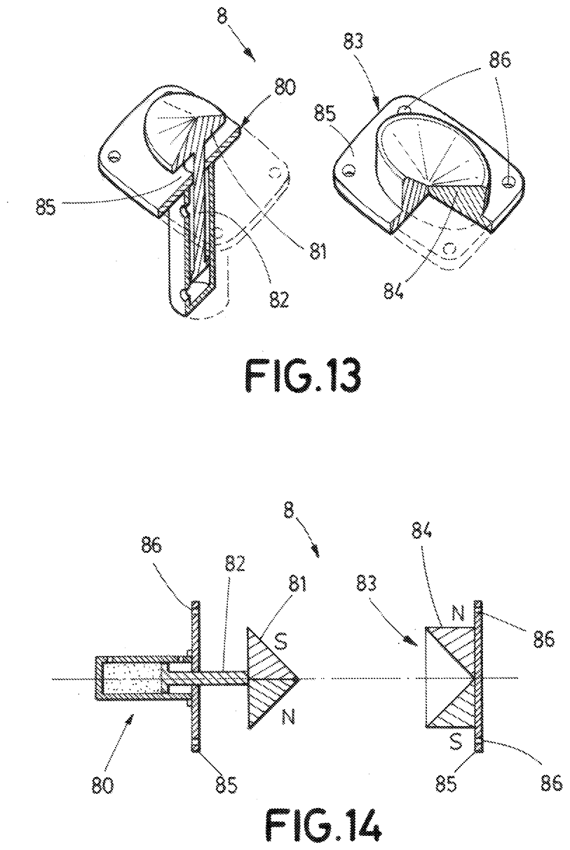

Observing FIGS. 13 to 15, one can see how, preferably, this device (8) has two parts, one male part (80), which is bolted to the frame of the door (4) of one of the modules (2) to be connected, and it includes an electromagnet (81) with the shape of a conical protuberance at the end of the rod of a pneumatic piston (82) which is that which buffers the connection, and a female part (83), which is bolted to the frame of the door (4) of the other module (2) to be connected, and it has another electromagnet of the opposite sign (84) in the shape of a sunken cone.

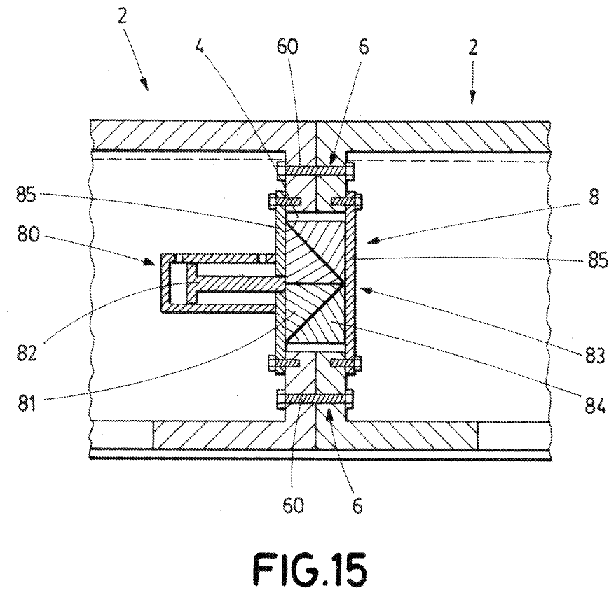

With it, in order to carry out the connection, principally what is done is tow a module (2) to the structure (1) until it is very near and then the final approach is controlled, adjusting the pressure of the doors of air entry of the pneumatic piston (82) and the intensity of the electromagnets (81, 84) and the modules (2) are aligned alone thanks to the magnetic fields. In FIG. 15, you can observe the finalized connection of the two adjacent modules (2), including the connecting thru-axles (60).

Once the connection is finalized, the modules (2) are fastened with the mechanical connection means (6) and, afterwards, the approach and buffering device (8) is dismantled, which can be used again in another connection. Next, the sealing means (7) are applied.

The complementary conical shape of the electromagnets (81, 84) increases the contact surface between them and, consequently, increases the retention force to facilitate the placement of the connection means (6).

In the example of the preferred realization shown in FIGS. 13 to 15, both the male part (80) and the female part (83) have a plate (85) with holes (86) for fastening by bolts to the door (4) of the module (2) in substitution of the cover (5).

Finally, FIGS. 16 to 21 show two examples of different options for enlarging the structure (1) by means of coupling additional modules (2″).

Specifically, FIG. 16 shows an example of the structure (1) with a cylindrical shape, formed by different types of space modules (2): comprising two equal modules (2) in the shape of a circular sector that form successive rings (1b), to define the circular walls of the tubular body of the structure (1), and similar modules (2) but with a smaller radius which, along with a central circular module (2), define the respective flat bases (1c, 1d) that close the ends of this tubular body of the structure (1).

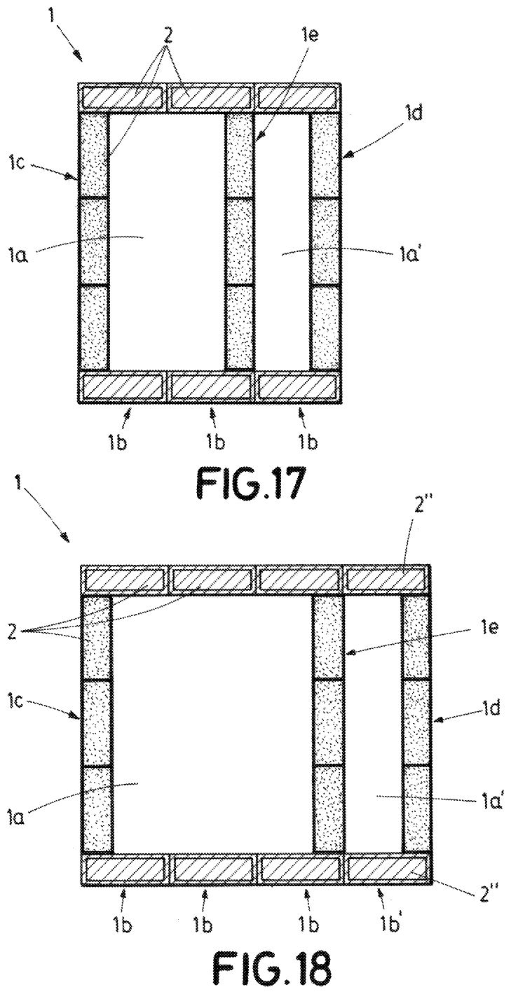

In FIGS. 17 and 19 one observes two options of the example in cylindrical form of the structure (1) of FIG. 16, represented in sectional view according to cut C, where it is noted that, in addition to the modules (2) that define the respective flat bases (1c, 1d) of the ends of its circular body, situated in these figures to the left and right of it, from the viewpoint of the observer, it also includes another set of interior modules (2) that define an interior partition (1e) that divides the interior hollow space (1a) of the structure (1) into two parts (1a, 1a′), defining two hollow structures (1) joined together.

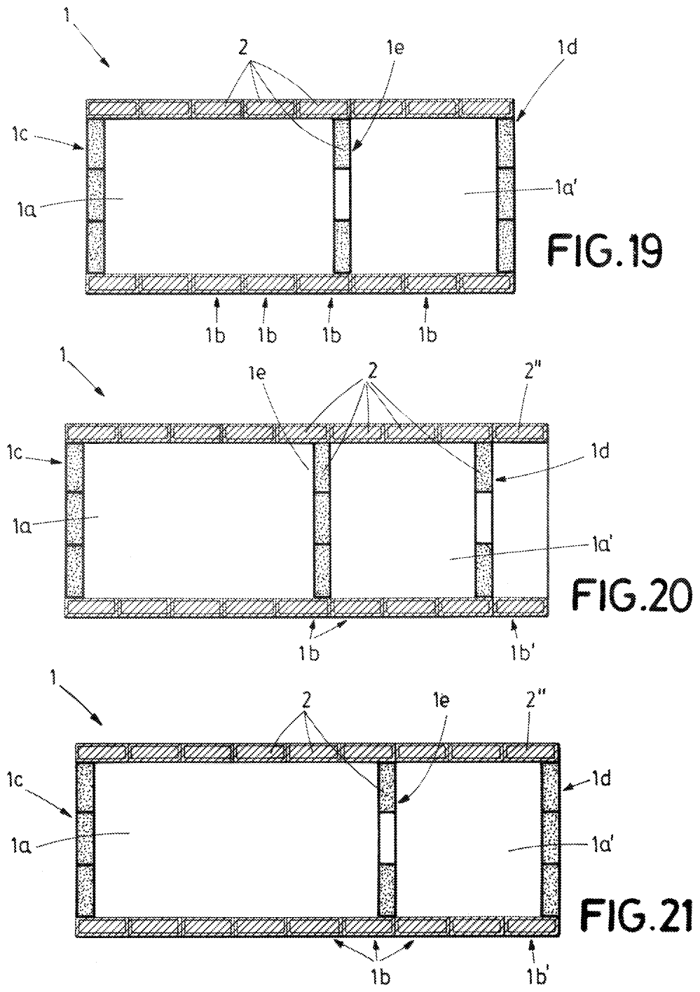

And from this configuration, this structure (1) can be enlarged in two different ways:
Incorporating additional modules (2″) already produced that are brought for such purpose from outside, the option represented in FIGS. 17, 18;
and incorporating additional modules (2″) that are produced within the initial structure (1) itself, shown in its principal phases in FIGS. 19 to 21.

Therefore, in the first option, in order to enlarge the cylinder that makes up the structure (1) on the right without compromising its pressurization, you would proceed as follows:
Additional modules (2″) are placed forming a new ring (1b′) just to the right of the right flat base (1d).
Once the new right (1b′) is formed from additional modules (2″), the modules (2) that form the right flat base (1d) are moved to the right and then pressurized again, closing the circle of this new ring (1b′).
Once the modules of the right flat base (1d) are sealed in their new position, the modules (2) that form the interior partition (1e) are moved towards the right and are sealed with the modules (2) of the ring located to the right.
The manoeuvre is repeated as many times as necessary until the structure (1) is enlarged to the desired level.

In FIG. 18, one observes how the part of the interior hollow space (1a) defined between the left flat base (1c) and the interior partition (1e) is larger than the other (1a′), upon being enlarged in the pressurized volume after the moving of the interior partition (1e), remaining sealed at every moment.

In the second option, shown in FIGS. 19 to 21, which preferably is carried out once the structure (1) is sufficiently large so as to have inside all that is necessary to produce an additional module (2′) in its interior, in order to enlarge it, you proceed as follows:
The interior partition (1e) is opened, removing the central module (2) (FIG. 19).
The additional modules (2″) are produced in the larger part of the interior hollow space (1a) and are stored in the smaller interior space (1a′) until you have sufficient additional modules (2″) to construct a new ring (1b′) in the cylinder.
Once we have sufficient modules to construct another new ring (1b′), the central module is added to the interior partition (1e) to be sealed once more.
Next, the right flat base (1d) is opened, removing its central module (2), proceeding to place the additional modules (2″) to construct the new ring (1b′) in this right side of the structure (1), as observed in FIG. 20.
Afterwards, you move the right flat base (1d) to the right, adding the central module and sealing it in order to move to the right the interior partition (1e) and its central module (2) is again removed (see FIG. 21).
The manoeuvre is repeated as many times as necessary to enlarge the structure (1).

Logically, each time that a module (2) is placed in its location the connection means (6) and the sealing means (7) described earlier are applied, so that, in the entire process of enlarging the habitat the astronauts work from within the hollow structure (1), from within the modules (2) or from within the tug of the modules, being protected from solar storms, solar radiations, cosmic radiations, space debris, micro-meteorites, etc.

Having described sufficiently the nature of this invention, as well as the way to put it into practice, it is not considered necessary to extend the explanation further as any expert in the subject may understand its scope and the advantages that are derived from it, stating that, within its essentiality, it can be carried out in other forms of realization that may differ in details from that indicated as an example, and to which the protection that is sought would also extend, as long as it does not alter, change or modify its fundamental principle.

1. A hollow structure to create pressurized space habitats comprising a pressurized space habitat created from a set of space modules that can be joined together in such a way that, once assembled, define a volumetric body of variable configuration with a pressurized interior hollow space, with the total volume of the structure being greater than the sum of the volume that occupy the volumetric bodies that these modules form.

2. The hollow structure described in claim 1, characterized in that the modules can be a pressurized space, that is, that define in themselves pressurized space modules.

3. The hollow structure described in claim 1, characterized in that there are structural modules that make up part of the perimeter of the hollow structure once assembled and can serve as a connection between parts of it.

4. The hollow structure described in claim 1, characterized in that there are multiple identical modules, susceptible of being produced in a standardized manner.

5. The hollow structure described in claim 1, characterized in that the modules present flat faces for connection through which they remain abutted and connected to the contiguous module, being fastened by connection means (6) and sealing means (7) that ensure the pressurization of the interior hollow space (1a) of the structure (1).

6. The hollow structure described in claim 5, characterized in that, to connect the modules, they have flat faces for connection that have, at least, one door whose shape and dimensions coincide in order to adapt to each other upon confronting the respective faces (20) of two adjacent modules (2) to be connected. These doors (4), once confronted, are fastened together and pressurized along the perimeter with the cited connection (6) and sealing (7) means, with the two modules (2) communicating internally with each other.

7. The hollow structure to create pressurized space habitats, according to claim 6, characterized in that the doors (4), especially when the space modules (2) are pressurized, are closed with an extractable pressurized cover (5) that is extracted to perform the connection with another module (2).

8. The hollow structure to create pressurized space habitats, according to claim 6, characterized in that the sealing means (7) are also incorporated in the interior joint between modules (2).

9. The hollow structure to create pressurized space habitats, according to claim 6 characterized in that the connection means (6) are mechanical connection means.

10. The hollow structure to create pressurized space habitats, according to claim 9, characterized in that the connection means (6) consist of thru-axles (60), bolts, tensor cables or similar.

11. The hollow structure to create pressurized space habitats, according to claim 6 characterized in that the sealing means (7) consist of a joint (70).

12. The hollow structure to create pressurized space habitats, according to claim 11, characterized in that the joint (70) is a band formed by two layers, one of Kevlar (71) and another of a thermoplastic material (72) so that when the band is heated on the connection of the modules, the connection of the modules (2) is thermo-sealed, and has reinforced edges with a metallic profile that are fastened by means of bolts or rivets (9).

13. The hollow structure to create pressurized space habitats, according to claim 11 characterized in that the joint (70) is protected against space conditions such as micrometeorites, cosmic radiations, solar radiations, extreme temperatures (−180° C. in the shade and 122° C. in the side lighted by the sun), or space debris.

14. The hollow structure to create pressurized space habitats, according to claim 6 characterized in that the sealing means (7) consist of cold welds, connection by means of a fabric seam, rubber with covers, glue or others.

15. The hollow structure to create pressurized space habitats, according to claim 6 characterized in that at least some modules (2) have a door (4) with extractable pressurized cover (5) in an internal face (21), that is, oriented towards the interior hollow space (1a) of the structure (1) once assembled, allowing access to it once the structure (1) is assembled and pressurized.

16. The hollow structure to create pressurized space habitats, according to claim 6, characterized in that, to facilitate the connection between the two doors (4) of their flat faces (2) of the adjacent two modules (2) to be joined, there is a device (8) for approach and buffering by means of a pneumatic piston (82) and electromagnets (81, 84).

17. The hollow structure to create pressurized space habitats, according to claim 16, characterized in that the approach and buffering device (8) is dismountable and reusable in other connections in assembling the same structure (1) by means of incorporating this device in the respective doors (4) of the modules (2) to be joined.

18. The hollow structure to create pressurized space habitats, according to claim 16, characterized in that the device (8) has two parts, one male part (80), which is bolted to the frame of the door (4) of one of the modules (2) to be connected, and it includes an electromagnet (81) with the shape of a conical protuberance at the end of the rod of a pneumatic piston (82) which is that which buffers the connection, and a female part (83), which is bolted to the frame of the door (4) of the other module (2) to be connected, and it has another electromagnet of the opposite sign (84) in the shame of a sunken cone.

19. The hollow structure to create pressurized space habitats, according to claim 1 characterized in that the structure (1) is expandable by means of coupling additional modules (2″) already produced that are brought for such purpose from outside and incorporating additional modules (2″) that are produced within the initial structure (1) itself.
